(19) United States
(12) Patent Application Publication
(10) Pub. No.: US 2015/0100389 A1
(43) Pub. Date: Apr. 9, 2015

(54) SYSTEMS AND METHODS FOR TRACKING USER-UPTIME FOR MANAGED PRINT SERVICES IN MANAGED OFFICE DEVICES

(71) Applicant: XEROX Corporation, Norwalk, CT (US)

(72) Inventors: Matthew DeROLLER, Webster, NY (US); Adam ELHASSEN, Victor, NY (US)

(73) Assignee: XEROX Corporation, Norwalk, CT (US)

(21) Appl. No.: 14/045,710

(22) Filed: Oct. 3, 2013

(51) Int. Cl. G06Q 10/06

(52) U.S. Cl. CPC G06Q 10/0639
USPC 705/7.38

(57) ABSTRACT

A system and method are provided for automatically tracking and reporting additional metrics to customers employing managed services accounts to track maintenance and resupply of consumables in managed office devices. The additional metrics suite may provide to the customers additional internal management tools that can be advantageously employed within customer organizations to increase user efficiency and productivity. Without significantly increasing a requirement for data collection through data collection channels by which the vendor already receives information/data from the office devices for implementation of managed services agreements, a vendor will be able to provide to its customer organizations additional analysis of collected information/data in the form of particular metrics that the customer organization can use to track, monitor, enhance or optimize user efficiency within the customer organization.

### BACKGROUND

1. Field of Disclosed Subject Matter

This disclosure relates to systems and methods for automatically tracking and reporting additional metrics to customer organizations in the context of managed services agreements regarding managed office devices. The additional metrics suite may provide to the customer organizations additional internal management tools that can be advantageously employed within customer organizations to increase user efficiency and productivity.

2. Related Art

Customer companies often operate local digital data exchange networks. In these networks, individual user workstations are networked together and linked, via combinations of wired and wireless communication channels, to one or more of central servers and processing systems, local and remote data storage units, image forming devices and myriad communication components that may be used for communications external to the local digital data exchange networks of the customer companies and organizations. Today, certain of these data processing and data storage components may be hosted as cloud-based components according to known methods.

For customer organizations that have extensive document production and reproduction requirements, image forming devices connected to the customer organizations' local digital data exchange networks are employed as components of the networked systems to generally meet these extensive document production and reproduction requirements. Organizations may make use of large numbers and types of image forming devices to particularly meet both routine and special document production and reproduction requirements for the customer organizations. In many office environment installations, routine document production and reproduction requirements are addressed by locally-positioned multi-function devices that may be shared by only a small group of users within the organization, while more extensive and special document production and reproduction requirements may be forwarded to more complex commonly-placed image forming devices and systems with more extensive capabilities. These latter image forming systems and devices are often shared, in the office environment, by a more expansive user population, even with individuals in the user population addressing print jobs to a particular more complex commonly-placed image forming device and/or system that is not located in a reasonable close proximity to the user.

Market pressures have led to competition among image forming device and system vendors that sell, support, service and/or otherwise supply, office devices, and particularly image forming devices, to customer organizations. Customer organizations are afforded an opportunity to shop for a best value for these devices. The best value may be determined by a customer organization to be based strictly on purchase prices for the office devices. More often, in today's more competitive and service-oriented operating environment and market, best value may be determined to include a combination of office device purchase prices and other considerations including, for example, office device managed services agreements and/or support contracts entered into with a particular vendor for the office devices purchased or otherwise procured from that particular vendor.

Managed services agreements can be structured in many different ways. In the past, managed services agreements need to be supported by some form of manual data entry or rudimentary information exchange, often with an operator in the loop, to provide to the managed services provider (vendor) with myriad indications regarding those particular services that the customer organization anticipated needing in the near future, e.g., what supplies and/or maintenance services were required or soon-to-be required. Many office devices, but particularly image forming devices of the types commonly used in office environments, include consumable components (“consumables”), for example. Some of these consumables are customer replaceable, depending on a complexity of the image forming devices or systems. Others of these consumables require, or benefit from, intervention by vendor-provided technical and/or service personnel making a service call to replenish or replace certain of the consumables, often “tuning up” the office devices in which the technical and/or service personnel are replenishing or replacing the consumables.

As automation has increased, vendors have developed systems, which they offer to their customers as part of the managed services agreements. In general, these managed services agreements provide to the customer organizations services for automated monitoring of the office devices that they sell or supply to the customer organizations. This automated monitoring is often conducted remotely from a remote monitoring center associated with the vendor, which uses combinations of communications channels to monitor a status of the office devices covered by one or more managed services agreements, including monitoring consumables levels, and otherwise monitoring certain fault indications, for the office devices. This monitoring is generally undertaken by a vendor's remote monitoring facility conducting a combination of wired and wireless communications with individually supported or managed office devices that may be accessed via the customer organization's local digital data exchange network. The monitoring affords the vendor the opportunity to provide real time, or just in time, support for monitored devices to the benefit of the customer organization. Benefits of these services include reductions in requirements for monitoring personnel and data entry at the customer organization's site, requirements for the customer organization to maintain on hand an inventory of consumables other than what may be replenished in a timeframe that can be compressed by automated monitoring, lost to downtime attributable to a failure to recognize local warnings of consumables depletion and/or more timely information provided to the customer organization regarding on-site repairs that may be made by the customer organization's personnel or more timely dispatch of vendor-provided technicians or service personnel to address more extensive maintenance issues.

### SUMMARY OF THE DISCLOSED EMBODIMENTS

To date, most managed services agreements with customer organizations tend to be directed at providing device-specific or device-centric support to the customer organizations. Interestingly, as the provision of automated service support has increased, significant amounts of information/data are collected by the vendors in order to carry into effect the specific requirements of their managed services agreements. As vendors continue to seek areas where they may be able to provide better service to their customer organizations, it would be advantageous to exploit elements of information/data that is, or could be, collected regarding actual employment of a customer organization's managed devices to provide a particular customer organization with an additional analysis of certain productivity metrics that may be extrapolated from the collected information/data.

In the managed print services (MPS) business, for example, particular vendors (or device providers/suppliers) seek areas in which they can differentiate themselves from other vendors to the benefit of their customer organizations. Additional services may provide opportunities for the vendors to mitigate the detrimental effects of certain pricing pressures and competition by commoditizing individual capabilities for which customers may have been more willing to pay in the past, but now may expect at no additional cost. To an extent that a particular vendor may be able to provide an additional service of advising the customer organization regarding an analysis of information/data that may lead to increased user productivity within the customer organization based on collected information regarding common use of devices monitored in conjunction with the managed services agreement, such a capability may set the particular vendor apart from its competition.

Without significantly increasing a requirement for data collection through data collection channels by which the vendor already receives information/data from the office devices, it would be advantageous for the vendor to be able to provide to its customer organizations additional analysis of collected information/data in the form of particular metrics to enhance or optimize user efficiency within the customer organization. An ability of the vendor to be able to provide an analysis that shows a correlation between user productivity and the services that the vendor provides may serve to clearly differentiate the vendor from its competition and provide further an opportunity for the vendor to expand its managed services business.

Exemplary embodiments of the disclosed systems and methods may provide unique opportunities to analyze currently-collected, or easily additionally-collected, information/data under a managed services agreement with the analysis being packaged for presentation to a customer organization in a manner that benefits the customer organization.

Exemplary embodiments may introduce a concept of “User Uptime” performance as a new metric to be tracked and reported under a managed services agreement. In embodiments, a method for tracking individual user uptime may provide a particularized analysis of individual user interaction with a set of monitored image forming devices and associated services (applications) in a manner that associates individual use of the image forming devices and associated services (applications) with an individual user (including tracking the location of the individual user at the time of use). The monitoring and analysis of this “user-device” interaction may aid the customer organization in optimizing its resources.

Exemplary embodiments may monitor a set of image forming devices and associated services, individually tracking specific metrics relating to each individual user in a user population that routinely may interact with individual ones of the set of image forming devices and associated services. The tracking may include, for example, information regarding a particular frequency of use of a particular image forming device by each individual user, a proximity of each individual user to the particular image forming device during use, and other contextual information regarding identification of each individual user, The contextual information may, for example, include each individual user's job role within the customer organization, a criticality of use of the particular image forming devices to the individual user's job, and other like information. The hierarchy of information/data collected may be tailorable to the customer organization's needs.

In exemplary embodiments, use of particular image forming devices and services by individual members of a particular user population may be tracked. A combination of this information, with that gathered, for example, above may afford the vendor the capacity to provide to the customer organization simple tracking and reporting of User Uptime, the analysis of which may be beneficially employed by the customer organization.

Exemplary embodiments may associate individual users in a user population with individual image forming devices from a family of deployed image forming devices to determine, through an analysis process, availability and use of enabled services to show User Uptime metrics to customer organizations.

Exemplary embodiments may employ the vendor monitoring system to provide a capacity by which individual users may be associated with individual devices with the above details around availability and use of enabled services. Information collected regarding this association may be advantageously analyzed and employed by the vendors to provide to the customer organization indications of User Uptime metrics.

These and other features, and advantages, of the disclosed systems and methods are described in, or apparent from, the following detailed description of various exemplary embodiments.

### BRIEF DESCRIPTION OF THE DRAWINGS

Various exemplary embodiments of the disclosed systems and methods for automatically tracking and reporting additional metrics to customer organizations under managed services agreements, will be described, in detail, with reference to the following drawings, in which:

FIG. 1 illustrates an exemplary overview of a remotely-monitored local digital data exchange network that is operable with the systems and methods according to this disclosure;

FIG. 2 illustrates an exemplary compilation of monitored available data elements that may be combined/analyzed to arrive at a new metric for customer organization use according to this disclosure;

FIG. 3 illustrates a block diagram of an exemplary remote monitoring system for automatically analyzing gathered information associated with a customer organization to provide an analysis of previously unanalyzed user metrics for presentation to a user organization according to this disclosure;

FIG. 4 illustrates a flowchart of an exemplary method for employing data gathered from a remote monitoring of image forming devices operated by a customer organization and subject to a managed services agreement in analysis of other user metrics associated with a customer organization according to this disclosure; and

FIG. 5 illustrates a flowchart for an exemplary method for applying the disclosed metric evaluation to predict other activities for user-device interaction according to this disclosure.

### DETAILED DESCRIPTION OF THE DISCLOSED EMBODIMENTS

The systems and methods for automatically tracking and reporting additional metrics to customer organizations employing managed services agreements, as described in this disclosure, will generally refer to this specific utility or function for those systems and methods. Exemplary embodiments described and depicted in this disclosure should not be interpreted as being specifically limited to any particular configuration of the described elements, any specific monitoring capacity or facility, any particular overarching analysis methodology or any limiting configuration of a remotely-monitored networked communicating environment. The exemplary embodiments should also not be interpreted as being specifically limited to any particular function or intended use. Any advantageous combination of the disclosed features, which may provide remote monitoring and additional analysis based on a particular managed services agreement between a vendor and a customer organization, to provide additional beneficial information to the customer organization is contemplated as being included in this disclosure.

Specific reference, for example, to any image forming device, as that term is commonly used throughout this disclosure, is intended to make non-limiting reference to common electronic and image forming devices, including printers, copy machines, facsimile machines and multi-function devices (MFDs) with a printing capability in a networked office workspace operating environment. These devices are those to which a plurality of users may forward work product from individual user workstations, either directly, or via a wired or wireless network component or components with which the individual user workstations may communicate in order that the work product may be output locally in hard copy by one or more of the devices. These terms should not be considered as limiting the disclosed subject matter to any particular configuration of those respective devices, as described. These terms are intended to refer globally, and inclusively rather than exclusively, to a class of devices and systems that carry out what are generally understood as printing and image forming functions, as those functions would be familiar to those of ordinary skill in the art.

Specific reference to, for example, any remote monitoring facility operated by a vendor (or device provider/supplier) should also be understood as being exemplary only, and not limited, in any manner, to any particular class of monitoring devices, components, capabilities or facilities.

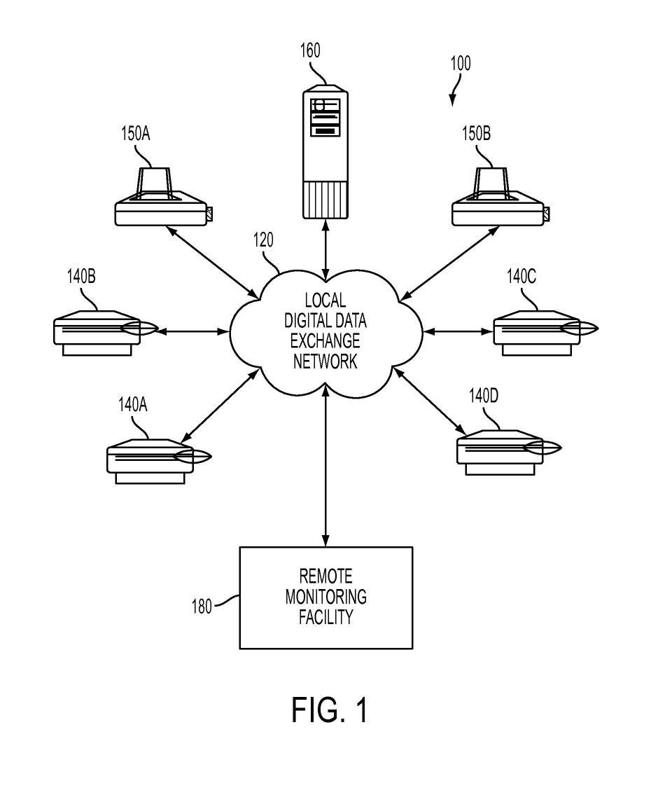

FIG. 1 illustrates an exemplary overview 100 of a local digital data exchange network 120 that may be operated by a customer organization within the customer organization's site. The local digital data exchange network 120 may support a number of image forming devices of differing configurations, shown in exemplary manner in FIG. 1 as first image forming devices 140A-D and second image forming devices 150A and B. As shown in FIG. 1, and as is commonly understood, the exemplary local digital data exchange network 120 may include any combination of devices including a plurality of user workstations (not shown) of various types coupled to, or in direct or networked communication with, one or more servers 160. Individual components of the exemplary local networked operating environment 120 may be individually connected to each other, or otherwise in communication with each other via some sort of central mainframe, by combinations of wired and wireless communications between individual elements. At least some of the server, mainframe, or supporting data storage and processing components may be located remotely from the customer organization's site, may be located at the remote facility and/or may be cloud-based.

A vendor that provides some number of the image forming devices to the customer organization may have a managed services agreement in place with the customer organization by which the vendor remotely monitors some or all of the image forming devices that the vendor has sold or otherwise provided/supplied to the customer organization. The vendor may operate a remote monitoring facility 180 that communicates with the local digital data exchange network(s) 120 of one or more of the vendor's customer organizations to provide support under managed services agreements with the individual customer organizations. A typical managed services agreement may provide that the vendor monitor an operating status for a number of image forming devices.

By virtue of its access to the managed devices, the vendor or device provider/supplier may be granted access for monitoring by its remote monitoring facility 180 to a veritable wealth of information/data regarding typical use or employment of individual ones of the image forming devices by individual users. The disclosed subject matter introduces a new analysis metric, which will be commonly referred to as User Uptime performance, tracking and reporting that may be provided to customer organizations as at least a part of their managed services agreements with the vendors. A method for tracking User Uptime through devices and services (applications) associated with that user is disclosed. A set of image forming devices and associated services may be linked with a particular user in a specified user population within the customer organization through particularly measurable metrics such as, for example, frequency of use of a particular device by a particular user, proximity of the particular device to the particular user when the use is initiated, specified characteristics regarding the user and/or other identifiable characteristics particularly measurable to support an analysis of user-device interaction for the customer organization. Individual uses of particular monitored image forming devices by particular users may be tracked. A combination of these approaches may be used to support an analysis that tracks and reports User Uptime to the particular customer organization.

Conventionally, quantitative tracking of image forming device mechanical/electrical and/or operational uptime is generally considered be the “bread and butter” of vendor services provided under managed services agreements. Vendor tools monitor the status of devices through the remote monitoring facilities to track al types of information including what may ber referred to as help desk incidents with details of device status, incident response and resolution times among other monitored metrics. In particular implementations, “Break/Fix and Supplies Tickets” may track high level and detailed status of devices and may be automatically created to ensure prompt response time for customer organization requirements by vendor personnel when required. Collected data in a number of associated categories may be comparatively readily available within managed services agreement account databases and may be used to generate performance reporting according to certain analysis and reporting techniques.

As presented broadly in this disclosure, the term “User Uptime” may be considered to result from combining multiple data elements. These data elements may include, among others, those that may be commonly collected as part of a managed services agreement between a device vendor and a customer organization. These commonly-collected data elements may include (1) individual device-specific uptime and operational statistics; and (2) specific services that each individual device may provide, or specifically be providing, in operational use. Other data elements that may be collected and/or analyzed that has not been the focus of conventional managed services agreements. The effort may include monitoring interaction of a user population with a collection of the customer organization's devices to track, in a reportable form, individual user-device interaction. The tracked user-device interaction may include an analysis regarding which individual devices particular users select for primary, secondary and tertiary use, and the like. The tracked user-device interaction may include an analysis regarding which particular services the particular users may select leading to trending and intelligent prediction of individual and global user services activity with regard to the devices within the customer organization. By associating users in this manner, and according to these and other details, with individual devices, details regarding availability and use of enabled services may provide the framework for an analysis that may be made available to the customer organization as a particular aspect of a managed services agreement to begin to show User Uptime metrics to the customer organization.

Details of available datasets may include the following that can be used for tracking User Uptime under a managed services agreement.

User Device Uptime: This data element is at the heart of the data collection generally undertaken to service most customer organizations by which managed services agreements are administered. Conventional tools monitor the status of devices, including MFDs, printers, copiers and the like. Differing device status determinations may be tracked including those that may be specified as device “operational” time, device “down” time, device “partial down” time (or limited availability). These differing device status determinations may be leveraged and complemented by a next level status determination to include details regarding particularly affected services, e.g. “Copy Down,” “Fax Down,” “Scan Down,” and the like. Through these varying levels of data tracking regarding status, device availability and the services the devices enable may be tracked.

Service Usage Pattern: When a user interacts with a device or service, this interaction may be tracked automatically. It is possible to associate a particular user with a specific device, set of devices, or selection of services based upon this automatically-tracked interaction. The automatic association update scheme may be sized appropriately to handle any level of user-device interaction in a dynamic use environment. Trending and performance metrics may be developed and provided in any granularity desired by the customer organization as the use initiated by individual members of the user population is tracked against the use of particular services from a primary device, secondary device and so on.

User Service Uptime: User Services are services provided by the vendor, typically with the devices being a key enabler and often supported by backend local or remote server components. Both the servers and the dependent devices can be tracked together as part of Service Uptime metric that is not limited to focusing on a particular device, but rather focusses on a suite of devices under the control of one or more server components. The data is generally conventionally available under most managed services agreements. User Service Uptime may represent a calculated result based on the device uptime and the services that the device enables correlated to data regarding which devices an individual user in the user population most often primarily and/or secondarily uses.

Service Availability: To determine if a service was available and if a user was impacted by a device status, the following elements may be associated with the particular user-device interaction and used for metric calculation:
Device Asset Status may be tracked through existing tools, including help/incident tracking processes.
User Primary and Secondary device associations may be tracked.
Any user job activity against a particular device under monitoring may be tracked.
Any user job activity tracked from use of a non-preferred device coupled with primary/secondary device out of service status indications during the relevant timeframe.
Trending past service use behavior against device status.

Menu options may be provided and displayed, for example, on a user interface by which individual data elements may be selected for collection. Any commonly-known methods by which to select or input information via a user interface may be employed, including, but not limited to, fillable forms, drop-down menus and the like. The user interfaces associated with this disclosure may run a full spectrum of available forms and modalities as follows. A user interface may be provided to a technician, administrator or other monitoring personnel at a vendor's remote monitoring facility. Separately, or additionally, a user interface may be provided associated with and integral to each monitored device. Otherwise, a user interface may be provided on one or more user workstations, such as one or more system administrator workstations, within the customer organization. Such a device-located user interface, or a customer organization workstation located user interface, may be made accessible to local personnel, such as users or administrators within the customer organization, or otherwise may be moded and/or programmed so as to exclude access of, and interaction by, customer organization personnel, in favor of access only being granted and/or otherwise being made available to vendor or device provider/supplier personnel.

The disclosed selectable menu options may be provided to a designated user in a familiar form that may allow, for example, the designated user to modify or customize a conventional ticketing system to select one or more additional (and perhaps new) “mandatory” data elements to be assigned to open an incident report. The data elements that may be selectable as menu options may be as high-level or as granular as a user, a customer organization or a vendor may desire, and may be according to particularly-negotiated tracking services available as aspects of the managed services agreements. In other words, the managed services agreements may provide ranges of additional services, and the user interfaces may be programmable according to the particular services that are contracted for out of the available ranges of services. In instances where job data may be collected from devices, this data may also be correlated against open incidents to determine what services were available.

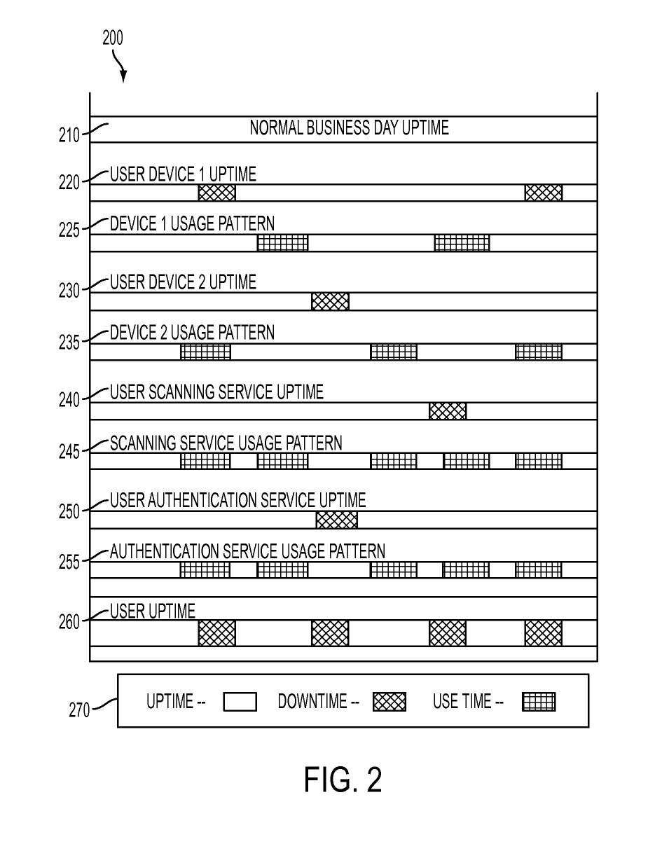

FIG. 2 illustrates an exemplary compilation 200 of monitored available data elements that may be combined/analyzed to arrive at a new metric for customer organization use according to this disclosure. In the exemplary compilation 200, a normal business day uptime 210 for the customer organization's overall system or family of devices may provide a basis for metric monitoring with a remote monitoring system according to this disclosure. Business (or general) time of day provides a convenient reference for monitoring and evaluation of device use. A legend 270 is provided in the depiction in FIG. 2 for interpretation of the exemplary compilation 200. Many individual metrics may be tracked by a vendor's remote monitoring system. In the example shown in FIG. 2, a device uptime 220,230 is monitored for Devices 1 (220) and 2 (230). Respective cooperating device usage patterns 225,235 are monitored for Devices 1 (225) and 2 (235). These metrics (or versions thereof) are typically collected today in support of certain managed services agreements. Separately and otherwise, other individual metrics may be tracked by the vendor's remote monitoring system. In the example shown in FIG. 2, user service uptimes, including user scanning service uptime 240 and user authentication service uptime 250, are monitored. Respective cooperating service usage patterns 245,255 are monitored, including a scanning service usage pattern 245 and an authentication service usage pattern 255. These metrics (or versions thereof) are not currently collected. With an analysis of this monitored and collected data, an algorithm may be applied, or the information may be simply graphically represented, in order to present a depiction of a User Uptime 260 according to this disclosure.

The disclosed embodiments, as is illustrated in FIG. 2, may uniquely track primary and secondary devices (and others) associated with individual users in a given user population. Further, calculating and tracking a new metric of User Uptime is introduced to provide a supplemental performance metric that may be advantageously offered by a vendor to a customer organization as an expanded aspect of a managed services agreement. The resulting benefits to the customer organization may include an opportunity to extend benefits of a managed services agreement well beyond such agreements' current reach by providing a monitoring, analysis and evaluation product by which individual productivity for employees of the customer organization, as the evaluated users, may be tracked and reported to the customer organization for their beneficial use, e.g., in managing and optimizing resources.

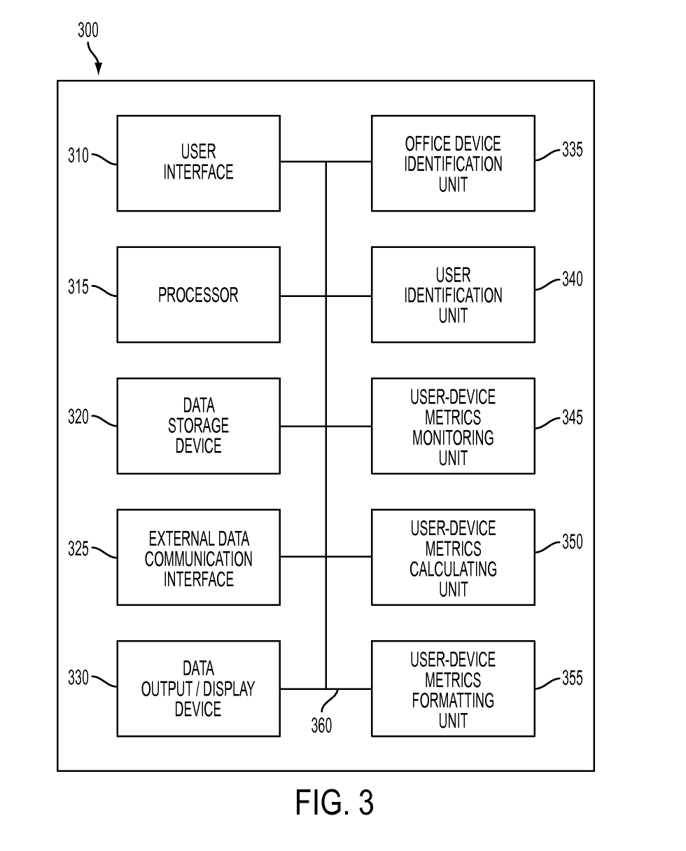

FIG. 3 illustrates a block diagram of an exemplary remote monitoring system 300 for automatically analyzing gathered information associated with a customer organization to provide an analysis of previously unanalyzed user metrics for presentation to a user organization according to this disclosure. The components of the exemplary remote monitoring system 300 shown in FIG. 3 may be embodied in a vendor's remote monitoring facility that may be in communication with a plurality of customer organization sites and specifically in communication with the local digital data exchange networks overseen by the individual customer organizations at their sites. Data storage and analysis elements depicted as being portions of the exemplary remote monitoring system 300 shown in FIG. 3 may be housed integrally with the other elements of the depicted exemplary remote monitoring system 300, or may be hosted separately, including, for example, in the cloud. An objective of the systems and methods according to this disclosure is to provide monitoring and support for a plurality of image forming devices located at each of several customer organizations' sites in a manner that is most efficient and effective for the vendor and is most non-intrusive to the operations of the customer organizations.

The exemplary remote monitoring system 300 may include a user interface 310 by which a vendor user, including vendor technical personnel or vendor administrator personnel, may communicate with the exemplary remote monitoring system 300. The user interface 310 may be configured as one or more conventional mechanisms common to typical computing devices and user workstations. The user interface 310 may permit a user to input information to the exemplary remote monitoring system 300 in order to facilitate the monitoring function for office devices at individual customer organization sites. The user interface 310 may be employed in conjunction with a data output/display device 330, described in more detail below, for a user to interact with displayed menu options that may be provided to the user by which the user may be presented individual data elements to be selected for collection. Any commonly-known methods by which to select or input information via a user interface 310 may be employed, including, but not limited to, fillable forms, drop-down menus and the like.

The exemplary remote monitoring system 300 may include one or more local processors 315 for individually operating the exemplary remote monitoring system 300 and for carrying out the remote monitoring and customer organization notification functions of the exemplary remote monitoring system 300. Processor(s) 315 may include at least one conventional processor or microprocessor that interprets and executes instructions to direct specific applications and functions with regard to monitoring a status of, and particular data metrics associated with, multiple image forming devices at one or more customer organization sites. Processor(s) 315 may initiate and control the monitoring and customer organization notification functions of the exemplary remote monitoring system 300.

The exemplary remote monitoring system 300 may include one or more data storage devices 320. Such data storage device(s) 320 may be used to store data or operating programs to be used by the exemplary remote monitoring system 300, and specifically the processor(s) 315. Data storage device(s) 315 may be used to provide information regarding managed service agreements with a plurality of customer organizations in, for example, a database identifying individual elements of tracked information regarding those managed devices as outlined in detail above.

Data storage device(s) 320 may include a random access memory (RAM) or another type of dynamic storage device that is capable of storing collected information, and separately storing instructions for execution of system operations by, for example, processor(s) 315. Data storage device(s) 320 may also include a read-only memory (ROM), which may include a conventional ROM device or another type of static storage device that stores static information and instructions for processor(s) 315. Further, the data storage device(s) 320 may be integral to the exemplary remote monitoring system 300, or may be provided external to, and in wireless communication with, the exemplary remote monitoring system 300, including being hosted in the cloud.

The exemplary remote monitoring system 300 may include one or more external data communication interfaces 325 by which the exemplary remote monitoring system 300 may communicate with components external to the exemplary remote monitoring system 300, such as local digital data exchange networks in multiple customer organization sites, to monitor a status of the devices in each of the customer organization sites to which the exemplary remote monitoring system 300 is connected for device monitoring. The one or more external data communication interfaces 325 may be specifically configured, as appropriate to communicate with individual customer organization local digital data exchange networks for forwarding to the customer organizations data and analysis of new metrics the beneficial use of the customer organization.

The exemplary remote monitoring system 300 may include at least one data output/display device 330, which may be configured as one or more conventional mechanisms, such as a display screen or a printer device, that output information to a user, for example, in a vendor's remote monitoring facility, regarding status of the exemplary remote monitoring system 300 and status of a plurality of office or image forming devices monitored by the exemplary remote monitoring system 300.

The exemplary remote monitoring system 300 may include an office device identification unit 335 that identifies particular devices within a customer organization to be particularly monitored for evaluation of additional metrics.

The exemplary remote monitoring system 300 may include a user identification unit 340 that identifies certain users in a user population within the customer organization such that the individual devices with which these users interact, or the specific services that these users request, are particularly monitored for evaluation of additional metrics.

The exemplary remote monitoring system 300 may include a user-device metrics monitoring unit 345 that may be usable to remotely monitor and collect data as to the operating status of identified office devices and identified users, and to potentially store the collected data in one or more of the data storage devices 320 for further review and analysis, particularly with regard to individual user-device interactions. The identified users in a user population within the customer organization and the individual devices with which these users interact, or the specific services that these users request, are particularly monitored by the user-device metrics monitoring unit 345 for evaluation of additional metrics.

The exemplary remote monitoring system 300 may include a user-device metrics calculating unit 350 that may apply an algorithm to the collected information/data to calculate one or more specified additional metrics, including a User Uptime metric as discussed above, that may be routinely presented to the customer organization for their beneficial use.

The exemplary remote monitoring system 300 may include a user-device metrics formatting unit 355 that may be usable to format the calculated information into a particular format that may be output, for example via the data output/display device 330 for use by the customer organization.

All of the various components of the exemplary remote monitoring system 300, as depicted in FIG. 3, may be connected by one or more data/control busses 360. These data/control busses 360 may provide wired or wireless communication between the various components of the exemplary remote monitoring system 300, whether all of those components are housed integrally together as a single unit, or are otherwise external and connected to a single integral unit as part of the exemplary remote monitoring system 300. It should be appreciated that, although depicted in FIG. 3 as an integral unit, the various disclosed elements of the exemplary remote monitoring system 300 may be arranged in any combination of sub-systems as individual components or combinations of components, integral to a single unit, or external to, and in wired or wireless communication with, the single unit of the exemplary remote monitoring system 300. In other words, no specific configuration as an integral unit or as a support unit is to be implied by the depiction in FIG. 3. Further, although depicted as individual units for ease of understanding of the details provided in this disclosure regarding the exemplary remote monitoring system 300, it should be understood that the described functions of any of the individually-depicted components may be undertaken, for example, by one or more processors 315 connected to, and in communication with, one or more data storage devices 320.

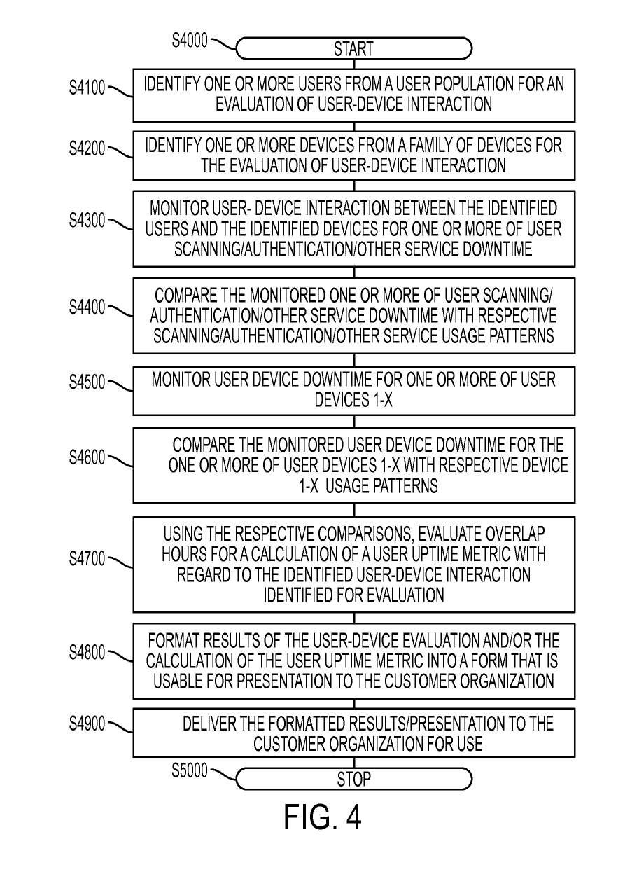

The disclosed embodiments may include a method for employing data gathered from a remote monitoring of image forming devices operated by a customer organization and subject to a managed services agreement in analysis of other user metrics associated with a customer organization. FIG. 4 illustrates a flowchart of such an exemplary method. As shown in FIG. 4, operation of the method commences at Step S4000 and proceeds to Step S4100.

In Step S4100, one or more users from a user population may be identified for an evaluation of user-device interaction in a customer organization. As a part of a managed service agreement the customer organization would need to provide to the vendor information on the user population to aid in the identification. Information on individual users may be any information that the customer organization chooses to provide, but would at least be the minimal information required by the vendor to undertake whatever level of User Uptime evaluation and analysis the customer organization desires. Operation of the method proceeds to step S4200.

In Step S4200, one or more devices from a family of monitored devices owned, leased and/or operated by the customer organization may be identified for the evaluation of user-device interaction in the customer organization. As a part of a managed service agreement, the customer organization may need to provide to the vendor information on placement of the individual devices in the customer organization working spaces/office environment to aid in the identification and further analysis. Information on placement of the devices and on typical interaction of members of the user population with individual devices may be of particular assistance to the vendor in undertaking the level of User Uptime evaluation and analysis that the customer organization desires. Operation of the method proceeds to step S4300.

In Step S4300, the monitoring function of the vendor monitoring facility may monitor characteristics of user device interaction between the identified users and the identified devices to track services that the particular users direct in the particular device and what may occur, for example, when a particular device, or a particular service, that the user desires in unavailable. The user's diversion of its request for services to a secondary or tertiary device may be evaluated, for example to result from one or more of a requested service device downtime. Operation of the method proceeds to Step S4400.

In Step S4400, the monitored one or more of requested service device downtime may be compared to one or more corresponding service usage patterns. Operation of the method proceeds to Step S4500.

In Step S4500, the monitoring function of the vendor monitoring facility may monitor downtime for one or more identified user devices, the monitoring tracking the particular services that particular devices are enabled to perform at any given time. The user's diversion of its request for services to a secondary or tertiary device may be evaluated, for example to result from one or more of a requested device downtime. Operation of the method proceeds to Step S4600.

In Step S4600, the monitored one or more of identified device downtime may be compared to one or more corresponding device usage patterns. Operation of the method proceeds to Step S4700.

In Step S4700, the respective comparisons may be used to evaluate device/service overlap hours for a calculation of a User Uptime metric with regard to identified user-device interaction identified for evaluation. This evaluation and/or calculation may apply a common comparative algorithm or may simply display results of the evaluation. Operation of the method proceeds to Step S4800.

In Step S4800, the results of the user-device evaluation and/or the calculation of the User Uptime metric may be formatted into a form that may be usable for presentation to the customer organization. Operation of the method proceeds to Step S4900.

In Step S4900, the formatted results/presentation may be delivered to the customer organization for use. Operation of the method proceeds to Step S5000, where operation of the method ceases.

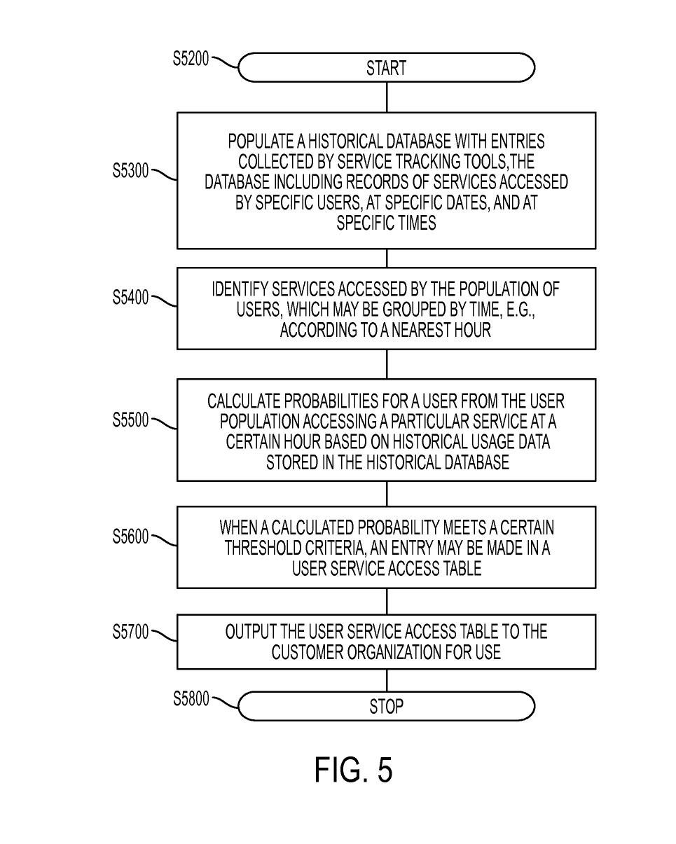

The disclosed embodiments include methods for applying the disclosed metric evaluation to predict other activities for user-device interaction. FIG. 5 illustrates a flowchart of such an exemplary method. Operation of the method commences at Steps S5200 and proceeds to Step S5300.

In Step S5300, a historical database may be populated with entries regarding collected by certain service tracking tools. The historical database may include records of services accessed by specific users including specific dates and/or times that the services were requested and by which devices user service requests may have been satisfied. Operation of the method proceeds to Step S5400.

In Step S5400, the historical database may be queried to identify which particular services may have been accessed by a population of users, including groupings of identified services particularly parsed by time of day according to a nearest hour. Operation of the method proceeds to Step S5500.

In Step S5500, probabilities for a user from the user population to attempt to access a particular service at a particular hour with one or more devices may be calculated. Operation of the method proceeds to Step S5600.

In Step S5600, the calculated probabilities may be compared to a threshold criteria, with entries, for example, being made in a service access table that may show devices and times that it is probable that a user may attempt to use. Operation of the method proceeds to Step S5700.

In Step S5700, a developed user service access table may be forwarded to the customer organization for use. The customer organization may use the provided information to, for example, determine when it may be optimal to take one or more devices out of service to accomplish preventive maintenance. These out of service decisions could aid in substantially improving an optimization of a device laydown, or an overall device operation scheme, in the customer organization. Operation of the method proceeds to Step S5800, where operation of the method ceases.

The above-described exemplary systems and methods reference certain conventional components to provide a brief, general description of suitable image forming devices and wireless and networked operating environments that may be particularly adaptable to the monitoring and analysis schemes according to the described systems and methods. Those skilled in the art will appreciate that other embodiments of the disclosed subject matter may be practiced with many types of local digital data exchange networks and image forming devices using the monitoring and analysis tools in networked environments in many different configurations.

The exemplary depicted sequence of executable instructions described in the above methods represents individual examples of corresponding sequences of acts for implementing the functions described in the steps. The exemplary depicted steps may be executed in any reasonable order to carry into effect the objectives of the disclosed embodiments. No particular order to the disclosed steps of the methods is necessarily implied by the depictions in FIGS. 4 and 5, and the accompanying description, except where a particular method step is a necessary precondition to execution of any other method step. Individual method steps may be carried out in sequence or in parallel, in simultaneous or near simultaneous timing, as appropriate.

Although the above description may contain specific details, they should not be construed as limiting the claims in any way. Other configurations of the described embodiments of the disclosed systems and methods are part of the scope of this disclosure.

It will be appreciated that a variety of the above-disclosed and colorably-related features and functions, or alternatives thereof, may be desirably combined into many related different systems or applications. Various alternatives, modifications, variations, or improvements therein may be subsequently made by those skilled in the art which are also intended to be encompassed by the following claims.

What is claimed is:

1. A method for evaluating user productivity in an office environment, comprising:
establishing communication with a plurality of devices;
identifying at least one user of the plurality of devices in a population of users of the plurality of devices;
detecting, with a processor, a communication between the identified at least one user and at least one of the plurality of devices, the communication being a service delivery request that directs the at least one of the plurality of devices to deliver a service;
tracking, with the processor, a response among the plurality of devices to the service delivery request;
analyzing, with the processor, the service delivery requests for the identified user and the responses among the plurality of devices to the service delivery requests over time to determine user-device interaction with the plurality of devices; and
reporting a result of the analyzing to an entity.

2. The method of claim 1, wherein:
the plurality of devices are a plurality of image forming devices in the office environment;
the plurality of image forming devices are remotely monitored by a vendor; and
the detecting, tracking and analyzing are accomplished by a processor associates with the vendor remote monitoring.

3. The method of claim 2, wherein:
the entity is a customer organization operating the office environment for which the vendor remotely monitors the plurality of image forming devices by agreement; and
the population of users are users operating under control of the customer organization.

4. The method of claim 3, wherein:
the customer organization provides information to the vendor regarding (1) individual users in the user population including at least positions of the users in the user population, and (2) the plurality of image forming devices including physical locations of the plurality of image forming devices in the office environment; and
the analyzing references the customer organization provided information to determine details of the user-device interaction with the plurality of image forming devices over time.

5. The method of claim 1, further comprising:
detecting, with the processor, a current operating state of the at least one of the plurality of devices when the service delivery request is communicated by the user; and
when it is detected that the at least one of the plurality of devices is at least one of out of service or unable to perform the requested service, detecting additional communications by the user to redirect the service request to another at least one of the plurality of devices.

6. The method of claim 5, the analyzing including cataloging the additional communications by the user as part of a same service request event to determine typical user response by the identified user.

7. The method of claim 6, further comprising repeating the identifying, detecting, tracking and analyzing for a plurality of users in the user population.

8. The method of claim 7, further comprising formatting the result of the analyzing to provide a report to the entity of user uptime for the determined user-device interaction for the plurality of users in the user population interacting with the plurality of devices.

9. A system for evaluating user productivity in an office environment, comprising:
a communication interface that establishes communication with a plurality of remote devices;
a user identification unit that identifies at least one user of the plurality of remote devices in a population of users of the plurality of remote devices;
a monitoring unit that detects a communication between the identified at least one user and at least one of the plurality of remote devices, the communication being a service delivery request that directs the at least one of the plurality of remote devices to deliver a service;
a processor that is programmed to:
tracking a response among the plurality of remote devices to the service delivery request; and
analyze the service delivery requests for the identified user and the responses among the plurality of remote devices to the service delivery requests over time to determine user-device interaction with the plurality of devices; and
an output unit that outputs a report of a result of the analyzing to an entity.

10. The system of claim 9, further comprising a data storage device that stores information to support the analyzing and results of the tracking and analyzing,
wherein:
the plurality of remote devices are a plurality of image forming devices in the office environment;
the plurality of image forming devices are remotely monitored by a vendor operating the processor;
the entity is a customer organization operating the office environment for which the vendor remotely monitors the plurality of image forming devices by agreement;
the population of users are users operating under control of the customer organization; and
the data storage device stores information that the customer organization provides to the vendor regarding (1) individual users in the user population including at least positions of the users in the user population, and (2) the plurality of image forming devices including physical locations of the plurality of image forming devices in the office environment.

11. The system of claim 1, the processor being further programmed to:
detect a current operating state of the at least one of the plurality of remote devices when the service delivery request is communicated by the user; and
when it is detected that the at least one of the plurality of remote devices is at least one of out of service or unable to perform the requested service, detect additional communications by the user to redirect the service request to another at least one of the plurality of devices,
the analyzing including cataloging the additional communications by the user as part of a same service request event to determine typical user response by the identified user.

12. The system of claim 11, the processor being further programmed to repeat the identifying, detecting, tracking and analyzing for a plurality of users in the user population.

13. The system of claim 12, the processor being further programmed to format the result of the analyzing to provide a report to the entity of user uptime for the determined user-device interaction for the plurality of users in the user population interacting with the plurality of devices.

14. A non-transitory computer-readable medium storing instructions which, when executed by a processor, cause the processor to execute a method for evaluating user productivity in an office environment, the method comprising:
establishing communication with a plurality of devices;
identifying at least one user of the plurality of devices in a population of users of the plurality of devices;
detecting a communication between the at least one user and at least one of the plurality of devices, the communication being a service delivery request that directs the at least one of the plurality of devices to deliver a service;
tracking a response among the plurality of devices to the service delivery request;
analyzing the service delivery requests for the identified user and the responses among the plurality of devices to the service delivery requests over time to determine user-device interaction with the plurality of devices; and
reporting a result of the analyzing to an entity.

15. The non-transitory computer-readable medium of claim 14, wherein:
the plurality of devices are a plurality of image forming devices in the office environment;
the plurality of image forming devices are remotely monitored by a vendor; and
the detecting, tracking and analyzing are accomplished by a processor associates with the vendor remote monitoring.

16. The non-transitory computer-readable medium of claim 15, wherein:
the entity is a customer organization operating the office environment for which the vendor remotely monitors the plurality of image forming devices by agreement; and
the population of users are users operating under control of the customer organization.

17. The method of claim 16, wherein:
the customer organization provides information to the vendor regarding (1) individual users in the user population including at least positions of the users in the user population, and (2) the plurality of image forming devices including physical locations of the plurality of image forming devices in the office environment; and
the analyzing references the customer organization provided information to determine details of the user-device interaction with the plurality of image forming devices over time.

18. The non-transitory computer-readable medium of claim 14, further comprising:
detecting, with the processor, a current operating state of the at least one of the plurality of devices when the service delivery request is communicated by the user; and
when it is detected that the at least one of the plurality of devices is at least one of out of service or unable to perform the requested service, detecting additional communications by the user to redirect the service request to another at least one of the plurality of devices.

19. The non-transitory computer-readable medium of claim 18, the analyzing including cataloging the additional communications by the user as part of a same service request event to determine typical user response by the identified user.

20. The non-transitory computer-readable medium of claim 19, further comprising:
repeating the identifying, detecting, tracking and analyzing for a plurality of users in the user population; and
formatting the result of the analyzing to provide a report to the entity of user uptime for the determined user-device interaction for the plurality of users in the user population interacting with the plurality of devices.
